(19) United States
(12) Patent Application Publication
(10) Pub. No.: US 2002/0147676 A1
(43) Pub. Date: Oct. 10, 2002

(54) Computerized evaluation of risk in financing tecnologies

(76) Inventor: Rashida Karmali, New York, NY (US)

Correspondence Address: Rashida A. Karmali, Esq., 99 Wall Street, New York, NY, 10005, US

(21) Appl. No.: 09/829,851

(22) Filed: Apr. 10, 2001

(51) Int. Cl. G06F 17/60

(52) U.S. Cl. 705/38; 705/35

(57) ABSTRACT

A computerized system for determining the range of investment risks based on identifying and quantifying the collective impact of critical business risks, on investment returns in technology enterprises. Business risks are identified and quantified to provide solutions to the ensuing performance relationships. These solutions are then individually applied to determine an optimal investment return on the overall company basis.

### FIELD OF THE INVENTION

This invention generally relates to a computerized system for assessing risk of investment in a technology enterprise, and, more particularly, identifying and quantifying the collective impact of critical business risks to determine an optimized solution for asset allocation on an individualized basis, while at the same time focussing on solving risks in the different levels of difficulty and seriousness.

### BACKGROUND OF THE INVENTION

The financing of technology enterprises has taken on significant importance in recent years, particularly with the advent of many new and complex inventions which the entrepreneurial inventors are turning into valuable assets. It has been recognized that different individuals will have differing investment objectives and needs. It has also been recognized that many technologies provide differing rates of return and levels of risk associated therewith. The intersection of these characteristics results in a confusing array of variables. To effect rational financing, there have been a number of methods designed to undertake due diligence and collect information regarding specific inventions, inventors, business sectors, technology types and market potential of products, and to allocate the selection of investment vehicles to compensate the risk in a manner corresponding to each technology. These systems work on a collective risk assessment approach and are subject to all the variances that working on individualized risk will create.

Within the last decade the hot stock market has created and/or depleted tremendous wealth for the ‘astute’ stock market investor. Such wealth fluctuation has led to a predicament for investors over where to reinvest this newfound or limited money. Generally, such money tends to flow to suppressed subsectors for whom market inefficiencies resulted in under valued stock prices. Since the biotechnology, information technology, software and Internet sectors of the stock market seem to fit this profile, many technology investors are wondering, if the time has come for new money to flow into specific technology sectors and lift the industry out of its protracted doldrums. In recent years, most Biotechnology and Internet executives have had an extremely difficult time raising the necessary financing to fund their companies' programs. Publicly held biotechnology companies with less than stellar clinical trial results have made cutbacks, consolidated internal programs and liquidated assets in order to stay afloat. The bubble seems to have burst for the unrealized potential of several Internet technologies. Investment analysts and venture consultants in the venture capital funds have become wary of virtual expectations. In essence, available technologies are now subject to stringent due diligence and risk assessment analysis for financing. This permits a more complete understanding and measurement of the available financing alternatives and permits a true assessment of risk in light of competitive technologies.

The business environment is subject to constant change, creating a dynamic set of business and financial risks that are difficult to identify and quantify. Thus, there is a need for innovative ways to monitor these changes and to manage the challenges posed by the changing risks. There is a plethora of information about standards for different businesses. However this information is not utilized effectively in most instances because of the cost of data mining and sorting. Pervasive in most valuation processes is a subjective application of factors. In other words, instead of applying competitive intelligence criteria or competitive technology intelligence criteria, investment strategies have been formulated based on inadequate due diligence.

### SUMMARY OF THE INVENTION

In accordance with the invention, systems and methods for computerized assessment of risk are provided for selectively identifying and quantifying the collective impact of critical business risks and determining an optimal financing allocation for individual technologies, based on competitive intelligence and competitive technology intelligence standards.

The present invention provides methods for computerized assessment of risk in financing whereby intelligent automation is introduced into an algorithm to allow the operator to monitor the risks after each evaluation, and identify the specific risks that require corrective measures.

The present invention also provides computerized or reflexive assessment of risk which proceeds to the nth assessment in a risk sequence until the outcome of the nth assessment is zero, or no risk, by intelligent programming of a computer device, wherein the program orders the next assessment in a particular progression only if the prior assessment falls in a range stored in memory.

In general, in one aspect, the invention is an apparatus for assessing a cumulative risk score on an n-bit data word. The apparatus includes a) memory storing the n-bit data word; b) means for sequentially reading out each of a series of risk assessments; and c) a processor means to identify and quantify risk problems in individual business risks.

In preferred embodiments, the number of risk assessments has an equal number of bits. The memory includes an array of chips, each of which includes a plurality of storage cells.

It is an object of the present invention to provide an improved system for selectively assessing available business risk for a technology company and determining an optimal financing allocation for individual development stages, benchmarks and milestones, in a technology cycle.

It is another object of the present invention to provide a data processing implementation for a financing management system, which recommends corrective measures for different business risks based on an aggregate cumulative score of different risk types. Each score is assigned to a risk level based on risk levels established for each industry standard from historical data and experience as well as recent trends and fluctuations.

It is yet another object of the present invention to determine the optimal allocation of available financing among the entire spectrum of technologies. This optimum defines the implicit comparative returns on the financing allocated in the context of market performance.

The paradigm allows a user to encounter a knowledge base through different risk levels which represent the user's “frame of reference” and describe the risk of investment, growth needs, market potential or choice sets. The paradigm also permits the analyst to incorporate into this “frame of reference” results of an independent due diligence process that is generally undertaken by an investment group.

The above and other objects of the present invention are realized in specific, illustrative, improved financing management systems designed for technology companies for individualization of financing allocations. In particular, the companies' current business risks and portfolios are considered in order to bring about optimization by corrective measures. Financing and investment strategies are finally based on objective risk evaluation results rather than based on the reputation or sales mastership of the central figures or on media hype and virtual risk measures.

The foregoing and additional features and advantages of the instant invention will become more readily apparent from the following detailed description of a specific illustrative embodiment thereof, presented herein below in conjunction with the accompanying drawing in which:

### DESCRIPTION OF THE FIGURES AND DETAILED DESCRIPTION OF THE PRESENT INVENTION

This invention generally relates to algorithmic systems and methods for assessing risk of investment in an enterprise, and, more particularly, identifying and quantifying the collective impact of critical business risks so as to find an optimized solution for asset allocation on an individual risk basis. This invention provides software that is capable of taking a user through a clear and easy progression of steps that lead to evaluation of said risk assessment as a cumulative numerical score.

The risk assessment algorithm is used to establish the initial risk position of a company, as well as to monitor the performance of the individualized risks in the management of a company. The risk position of a company establishes financial parameters for risk tolerance, identifies the severity of potential problems and predicts the probability of losses. Risk assessment is intended as a starting point for any business enterprise, including, but not limited to, biotechnology, Internet, information technology, health care, chemical processing, communications, software, chemical processing, nanotechnology, bioinformation or medical devices.

There are various risk categories and sub-categories. Risk categories include, but are not limited to five categories: tangible assets, intellectual property, personnel, financial liquidity, and current or potential liability. These are the basic default values for the configuration of the system. Each category is further divided into sub-categories: Tangible assets represent the business property and infrastructure, and product inventory and products approved in the pipeline.

Intellectual property includes research and development, as proprietary intellectual property owned by the company wholly or in part. It also includes quality of science, name brand university as site of invention, dominating, pioneering or credible science and public view and needs.

Personnel include management staff, the technical staff and the administrative staff as well as the quality of people involved, their credibility and sell-ability. Financial liquidity includes amount of cash available, outstanding debts, bankruptcy, collateral credit, government control, interest rates, availability of funds in the financial markets, price/earning ratio, (P/E), market trends and access to funding sources. It also includes interest from and deals with corporate partners.

Liability may be in the form of owner's liability, litigation, third-party liability, employee conflict, infringement of intellectual property, bad debts, contract disputes or product related disputes.

Technology enterprises or industries include such sectors as biotechnology, chemical, communications, bioinformatics, health care, nanotechnology, Internet, information technology, medical devices or software.

Risk factors are related to a company's objectives as a means of identifying risks and their impact on the company. An algorithm is developed to identify, assess and evaluate risk exposures. A Company can benefit from regular risk assessment when a consistent approach is used to identify existing and new risk and prompt corrective action is taken by developing short, medium or long-term priorities for risk control. These regular risk assessments can be monitored and updated with the user-friendly interface that will assess existing files for technology or business. This system will also be regularly upgraded to ensure use of the most competitive intelligence and the most competitive technology intelligence.

Risk is a measure of the probability and severity of adverse effects. Having identified a risk category, the next step in the algorithmic evaluation is to divide the category into sub-parts and test each part to the nth level.

Once a group of questions are formulated for a particular technology enterprise, these questions are used to facilitate the algorithmic evaluation of individual risks. A numeric cumulative risk score is allocated for each risk category, along with a breakdown of different levels of risk for that particular risk category. For example, a score of zero is considered to be a no risk situation, without no exposure to risk of the company, its operations or its investors. The scores are developed from data available on specific industry standards for a particular technology. Where not readily available, these databases are prepared as part of the invention in order to effectuate competitive standards for intelligence in general, and for technology intelligence. The scores are also developed from the results of individualized due diligence carried out by corporate and intellectual property attorneys, accountants, or experts, in any financing deal.

A score of one is considered a low-level risk, wherein operations may be virtually unaffected, senior managers or investors are unaware of the risk impact and do not take any action.

A score of two is considered a low-medium level risk, wherein operations may be affected to some extent, but may not be stopped; senior managers are aware of the situation but may not need to act; and investors are probably not aware of the situation, but if they are, no action is taken.

A score of three represents a medium level risk wherein, operations are affected and may be stopped temporarily; senior managers are aware of the situation and probably have to act to limit consequences; and investors are aware of the situation and may contact senior management about it.

A score of four depicts a medium high level of risk wherein; operations are affected to the point where they are curtailed for a significant period. As a result, senior managers must act to limit consequences especially since the investors are aware of the situation and demand action.

A score of five represents high risk and generally operations are curtailed indefinitely or completely eliminated. Even when senior managers act it may not be enough to limit consequences. As a result, investors refuse additional funding, and may withdraw from the company.

The computerized risk assessment system of the present invention is a means of defining and quantifying risks associated with a business entity and thereby allowing assessment of risks and identification of specific risks that need corrective action. The system is flexible and gives the user the option of choosing from a myriad of default values stored in drop-down menus of masters, such as risk categories, risk sub-categories and industry categories, or choosing to define their own set of values.

FIG. 1 generally illustrates an embodiment of a computer-based system according to the present invention. The computer-based system includes at least one client computer and may or may not include a server computer. The client computer and the server computer can each access the Internet and thus follow market trends.

FIG. 2 is a schematic illustration of a computer, and is representative of a client computer. As shown in FIG. 2 a typical computer includes a processor connected to a memory system via an interconnection mechanism. An input device is also connected to the processor and memory system via the interconnection mechanism, as is an output device. Exemplary input devices include a keyboard, a keypad, a track ball, a mouse, and a communication device. Exemplary output devices include a cathode ray tube display (CRT), a liquid crystal display (LCD), a printer, storage devices, communications devices and audio devices.

FIG. 3 is a block diagram of the platform, which as a whole, comprised of the five interfaces in sequence, which make up the framework fro the software. As shown in FIG. 3 the system allows the user to identify and divide a risk category into sub-risks and further on into individual risks. For each risk the user sets up a flow diagram linking processes and questions to form the framework for the assessment questionnaire. The risks then are assigned values (scores) related to the chance and potential effects of their negative impact. Once the risk is defined, the system stores the details of the flowcharts and scores in the database, which is made available to the system whenever a particular risk is to be assessed. These scores and flowcharts will be guiding the user through the primary and other assessments and will result in a calculation of the cumulative risks for the sub-risks and entire entry. The overall impact of the risk will be shown by the system in the form of a graphical representation.

The system comprises five sets of interfaces including:

1. Interface for definition of masters, which includes drop-down menus of default values as well as the option to create new values

2. Interface for subdivision of risk categories for each industry category into individual risks, which includes drop-down menus of default values as well as the option to create new values

3. Interface for setting up the flow-charts and risk values that make up the framework for the assessment portion of the system.

4. The interface for risk assessment: provide the user with the questions according to a predefined progression; obtain scores by the answers given by the user; calculate cumulative scores for each risk category; and provide a graphical representation of the impact of the risk.

5. The interface reports on results of assessment categorizing risks as high priority, medium priority or low priority. The operating environment includes front end Visual Basic 5/6 and a Back end database access.

The Risk Management System of the present is a means of defining and quantifying risks associated with a business entity and providing for an algorithmic assessment of risks allowing identification of specific risks that need corrective action. This module facilitates a user (analyst) to define and quantify risk for a particular industry.

The module provided allows the user to Select /Define and submit details concerning a particular industry, identify risk categories & sub category. For each individual risk, the analyst sets up a progressive questionnaire and allocates scores for each level of progression for every possible option available. This is defined in the form of a flow chart showing the questions as a progression and the scores associated with every option. Scores can range from 0-x where a score of zero indicates no risk while a score of x indicates high risk. Once the questionnaire is defined, and the scores are allocated, system should store the details in the database, which in turn is made available by the system whenever a particular risk is to be assessed.

The first screen of the module, the main screen, is shown in FIG. 4.

FIG. 5 to FIG. 8 demonstrates a series of pages in which new company type can be defined and their corresponding Parent Risks can be defined.

FIG. 9 to FIG. 13 describes a series of tasks in which the Sub-Risk categories are entered and profiled. There is a facility of copying the existing Risk or Sub-risk and pasting either the Recommendation or the Question Flow or the entire Risk. For the Parent only the Recommendation can be pasted.

FIG. 14 represents a screen which helps one to define the flow for the Sub-Risk i.e. it allows you to define the Questionnaire for the Sub-Risk. Initially the user has a Start object on the upper left corner. He can drag this object anywhere on the screen by selecting it and placing it wherever desired. On the left there are various Buttons. The purpose of these Buttons is explained in (a) to (f).

(a) This is a default Button that has the focus initially.

(b) On selecting this Button you get a process object on the upper left corner. The user can drag this object to the desired position and can edit the caption by right clicking on the object. He gets the following pop-up.

(c) Select this to remove the selected process. Select this to change the description of the process and you get the following screen.

(d) On selecting this Button a question object comes on the upper left corner. The user can drag the object to the desired position by selecting the object. This object is used to define the questions for the Questionnaire Flow. Any number of question objects can be defined in the flow. For editing this object the same steps as above are repeated.

(e) On selecting this Button, a link can be selected which joins any two objects. Left click on the object from which the link is to be started and leave on the object with which the link is to be made. To edit the links repeat the above steps. Whereas to assign a score to the link, select the score option from the menu displayed on right click, as shown below. The Link coming out of Process and Start object cannot have a score defined.

(f) Remove the selected link, or Enter the Link Name and Score for the link in the following screen.

FIG. 15 represents a specific embodiment of the invention and demonstrates a screen, which shows the flow for the Patent Sub-Risk.

FIG. 16 provides a screen showing a risk range definition. All the Ranges entered must be Unique. You can assign ranges for any number of Risk Levels but both Range To and Range From fields are mandatory.

FIG. 17 describes a screen that shows the completion of the procedure for defining the Risk associated with a new company.

FIG. 18 demonstrates a page for an existing Company Type, which can be selected and its corresponding Risks.

FIG. 19 describes a page for existing Sub-Risks. Select the Sub-Risk whose definition is to be altered. Then click on the Define Flows. This displays the flow previously defined for that Sub-Risk. You can define or modify the flow as shown above. The user cannot add a Sub-Risk to a leaf node, if the flow for it has already been defined. If the user wants to define the flow for it, it will overwrite the existing definition.

Define the Risk and the Recommendations for the Added Sub-Risk

FIG. 20 and FIG. 21 describe pages in which the module helps to Select/define the company, for which one wants to assess the risk. Select the risk for evaluation. System in turn will ask progressive questionnaire to the user (Once a group of questions have been answered, system fetches the scores from the database according to the answers given. Results of scores available as answers to the questionnaire will be stored by the system.). The algorithm basically traces paths of the flow chart to arrive at a particular result. Sum of these scores will help the system judge the risk impact associated with a particular risk. Various such scores given to that individual risk will be used by the system for calculation of cumulative risk for a particular category. A graphical representation of the path traversed in the flow chart by the user will be displayed. User will have an option of retrieving the previous assessment.

FIG. 22 and FIG. 23 describe steps of assessing Sub-Risk. (“X”) This will be followed by a number of Questions. After the last question you get the following screen shown in FIG. 22. Select the Recommend button and following screen appears.

FIG. 24 describes a page showing suggested recommendations for the company to follow.

FIG. 25 describes the path traversed while answering the algorithmic questionnaire.

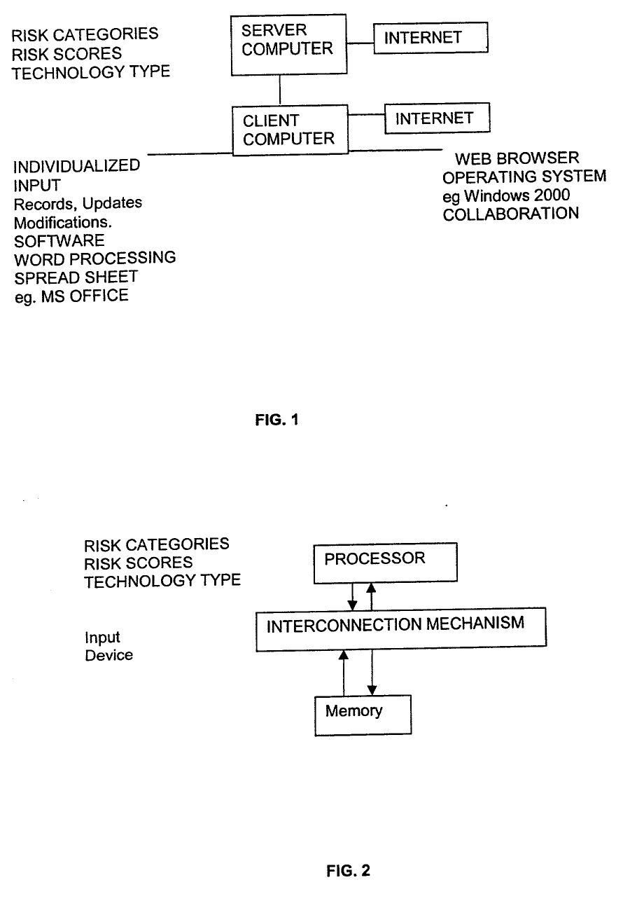

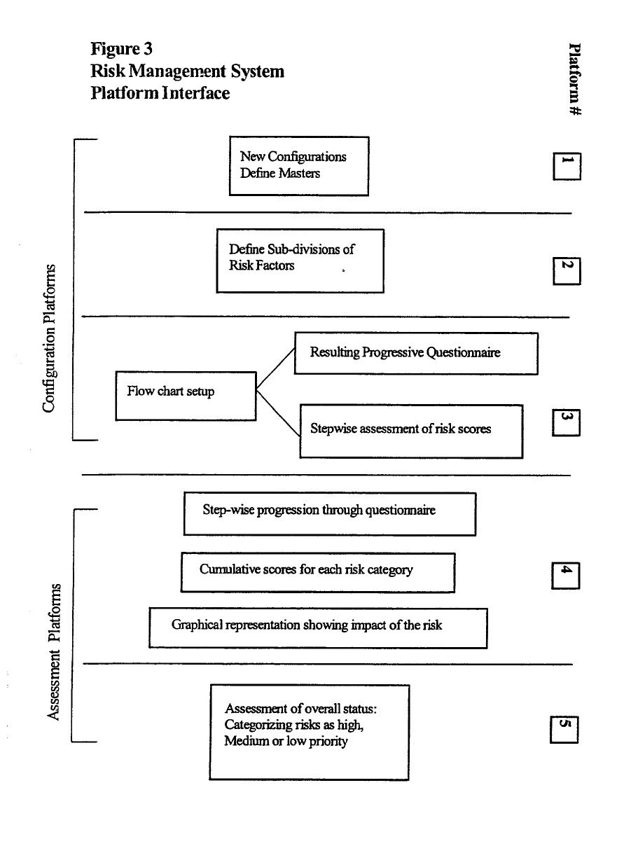

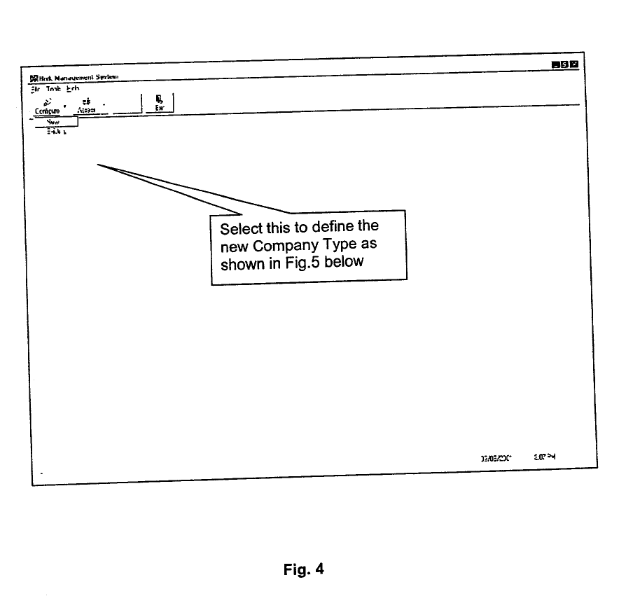

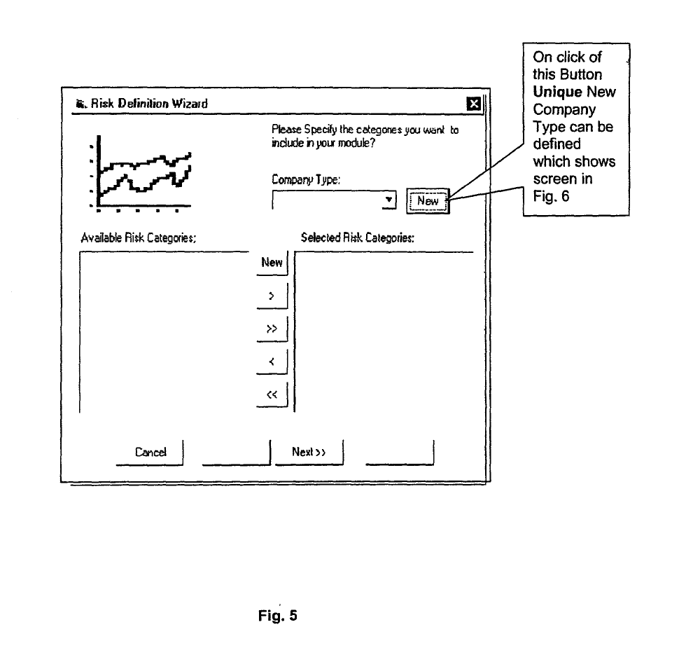

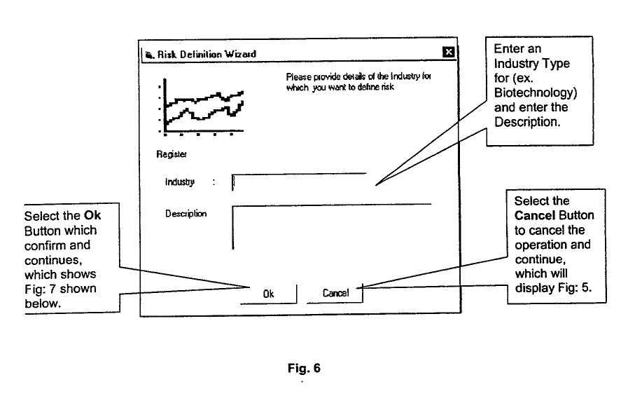

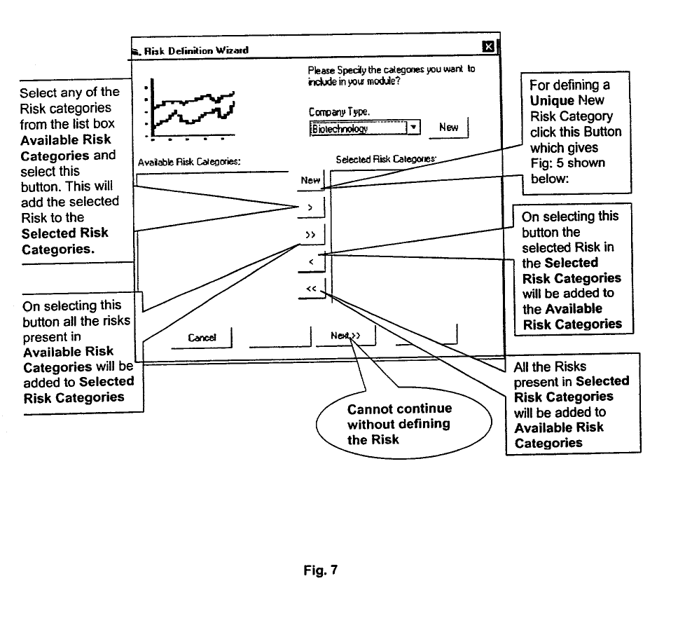

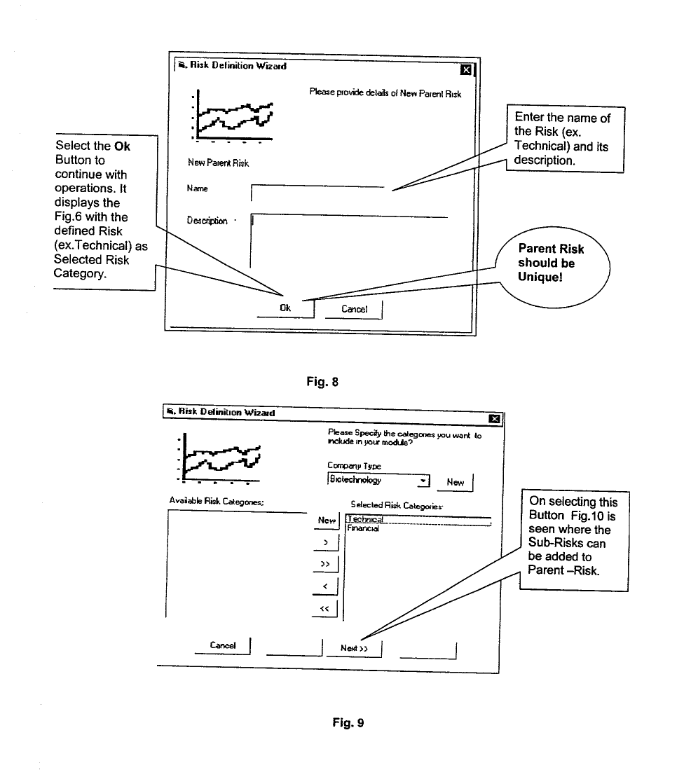

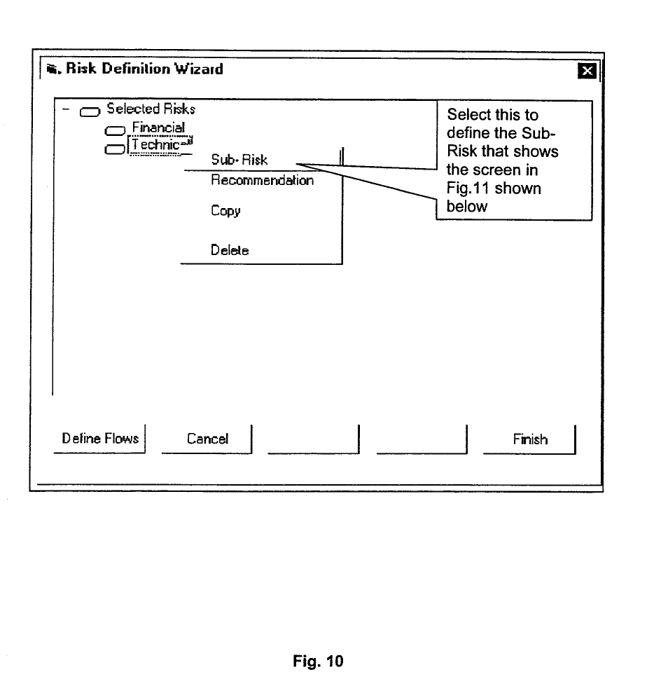

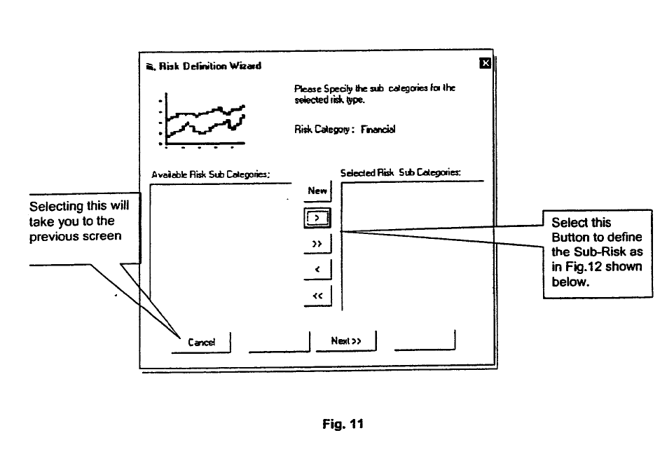

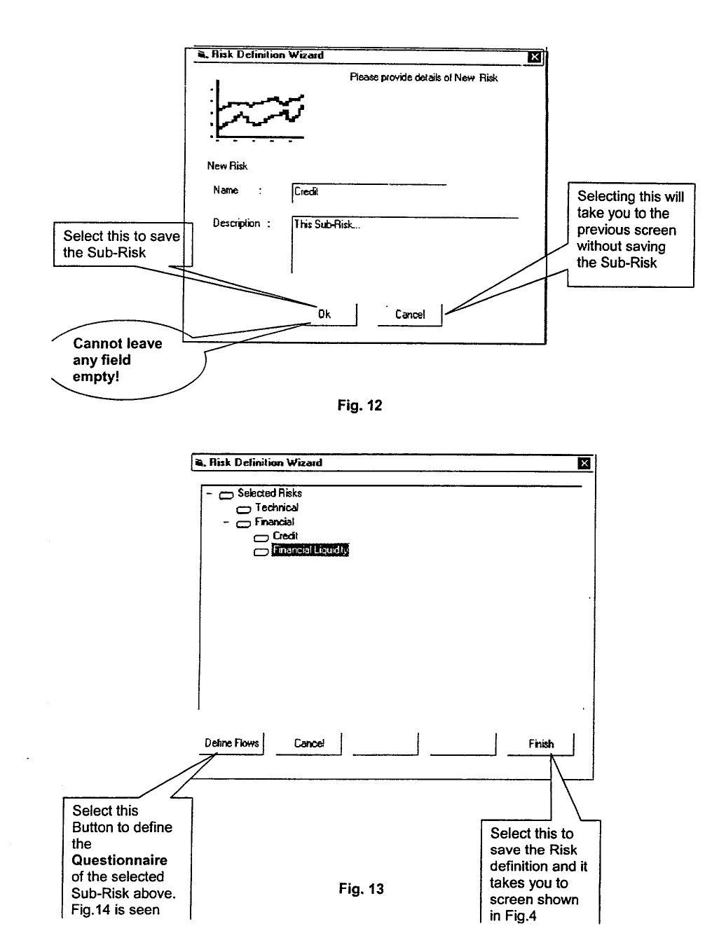

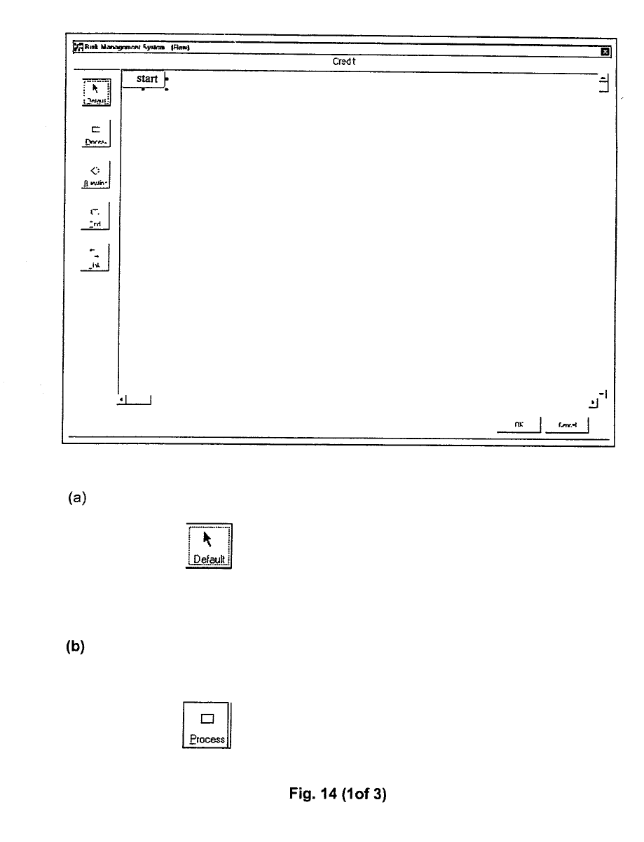

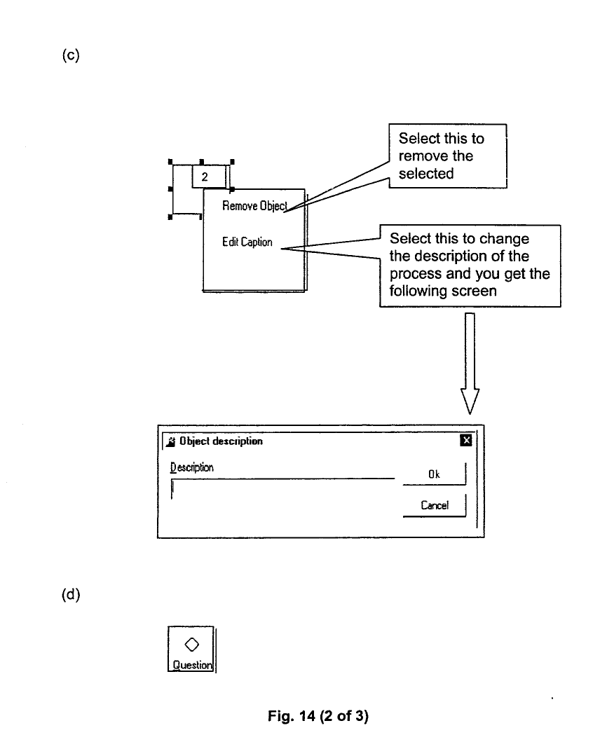

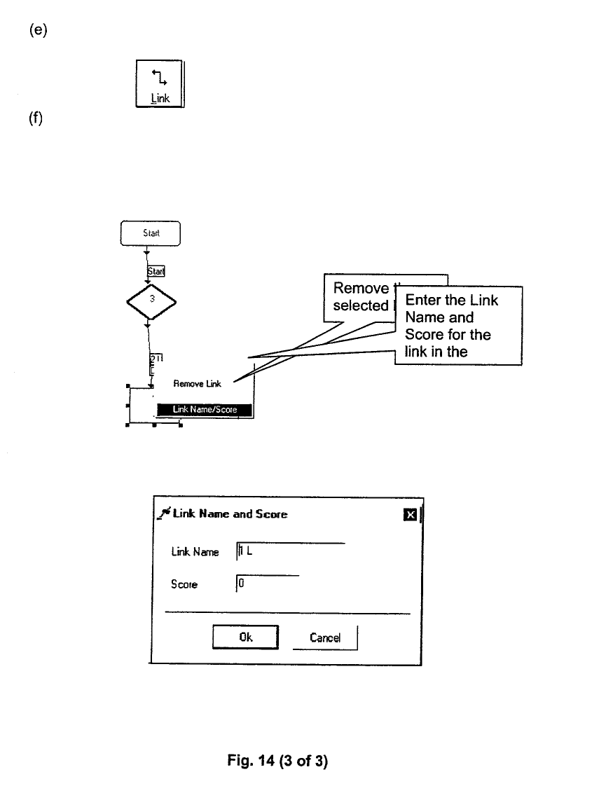

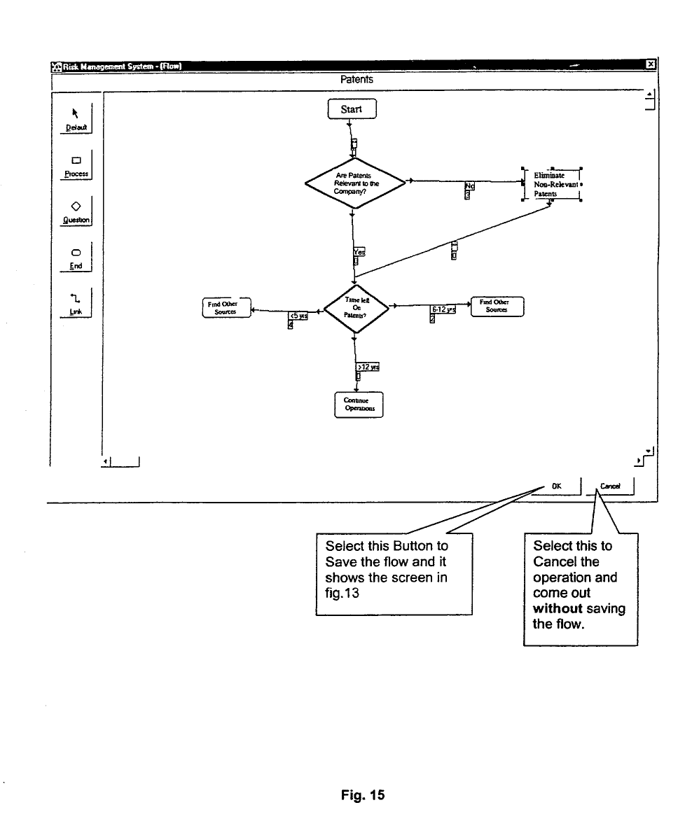

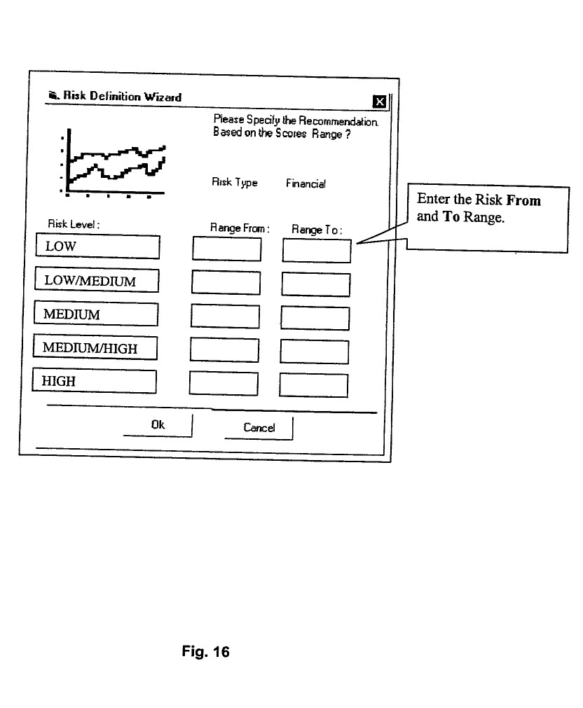

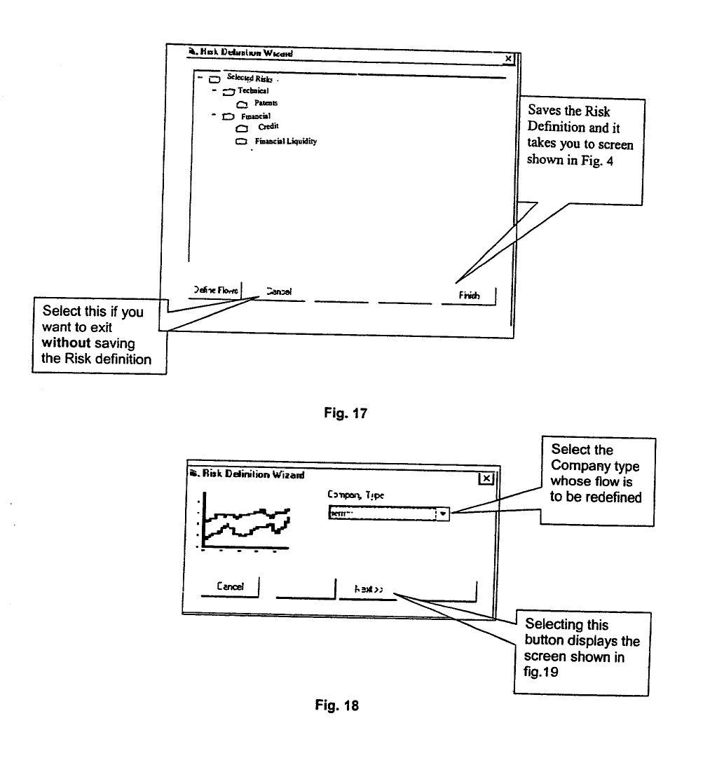

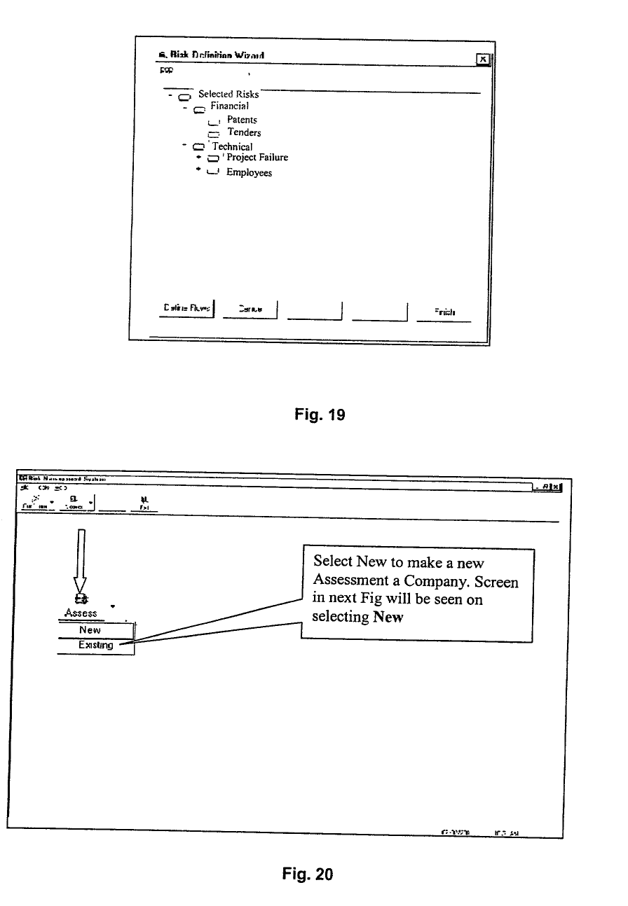

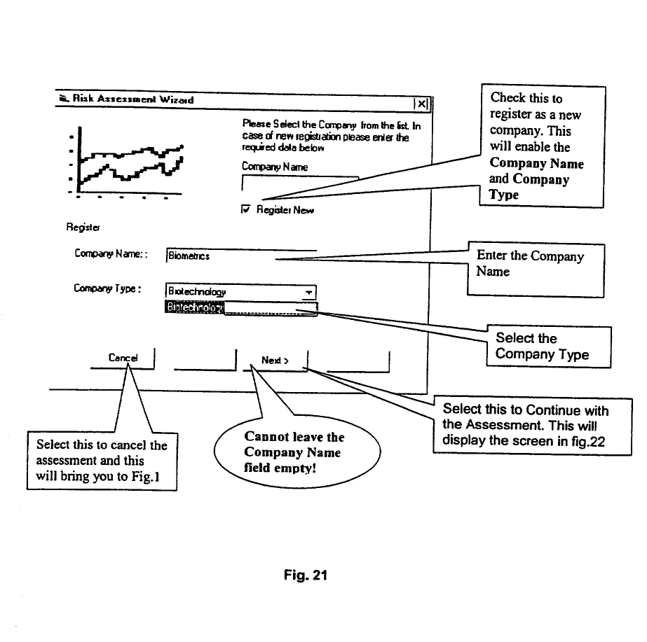

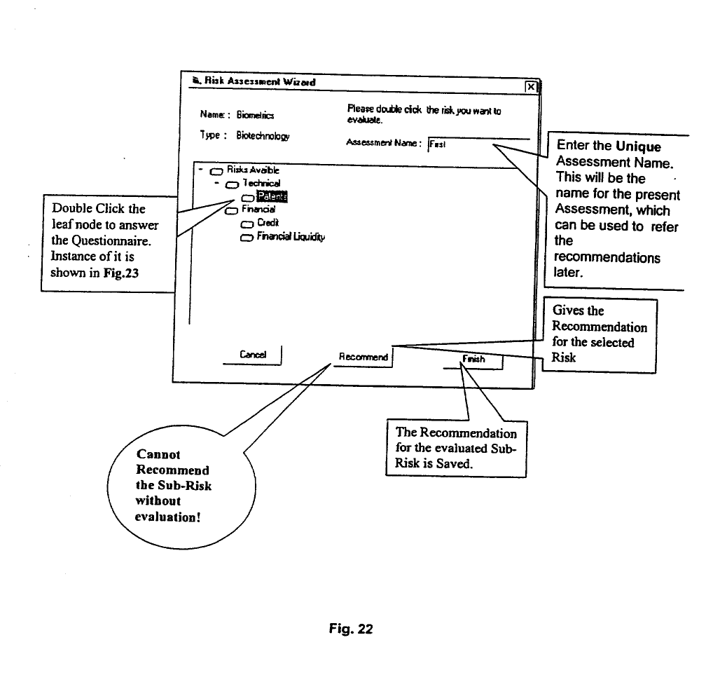

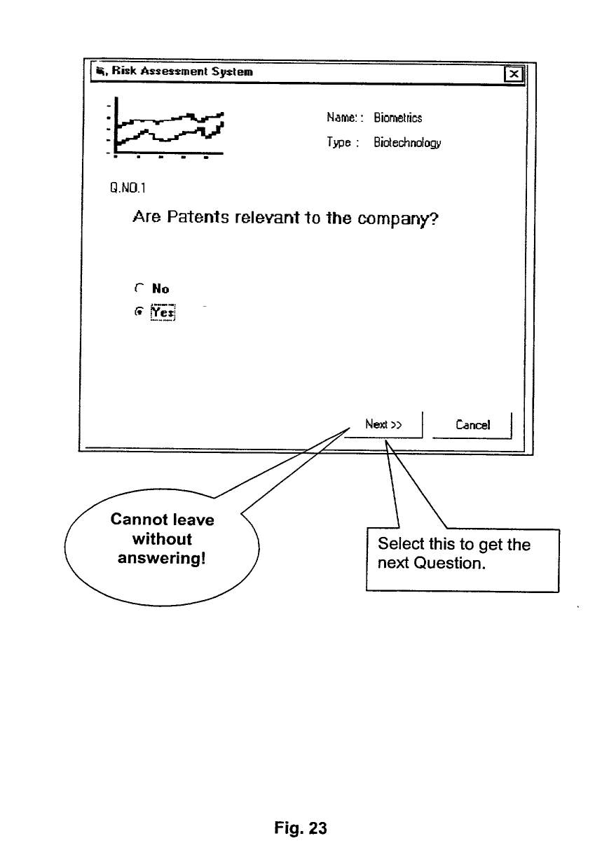

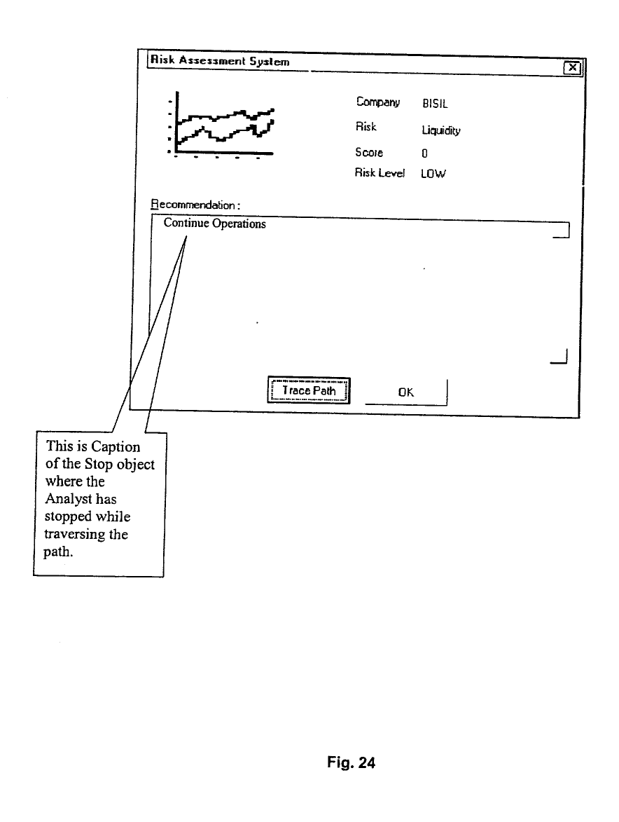

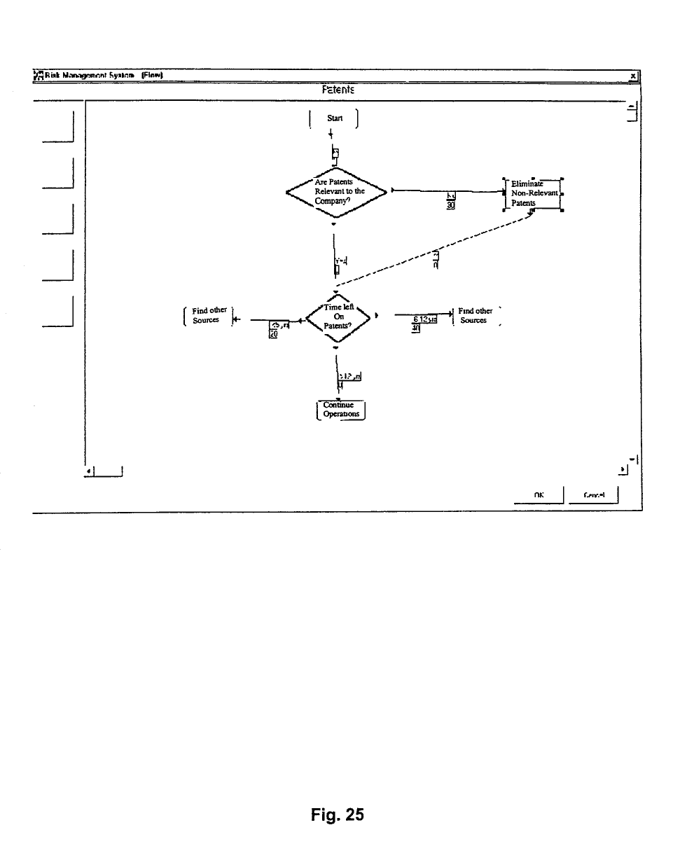

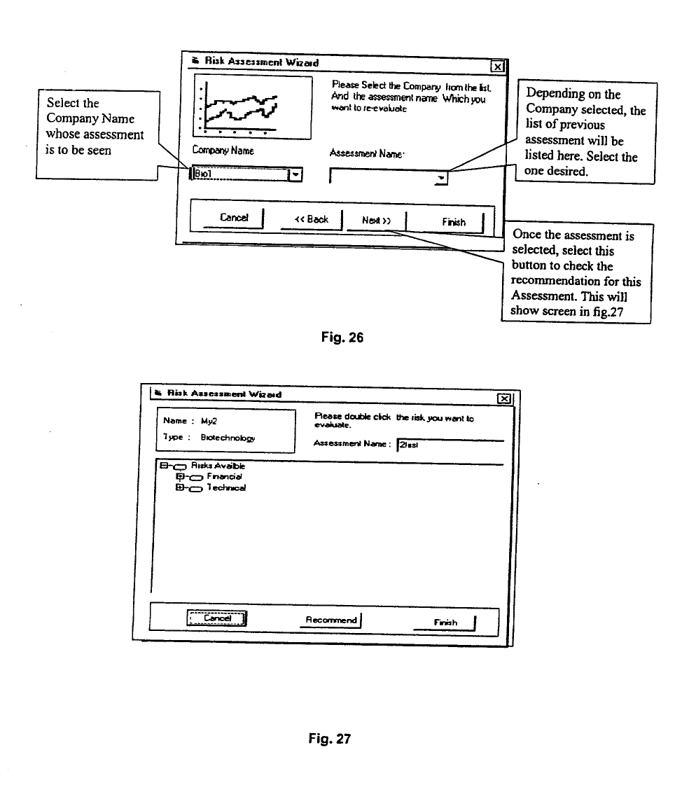

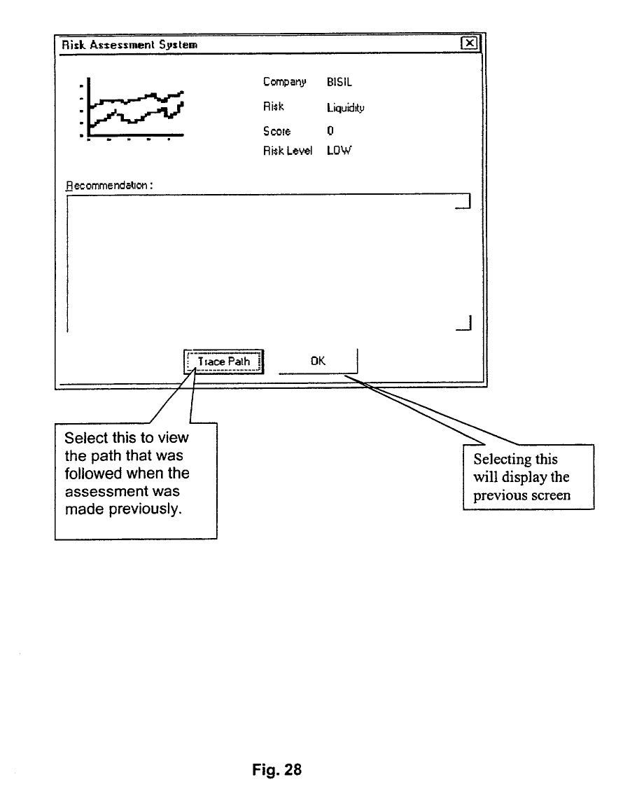

FIG. 26 describes a page showing existing risk assessment. The assessment made previously can be assessed to see the previous Recommendations or to do the Assessment once again. For this select the Existing option instead of New from screen in FIG. 1 of 3.3.1. The screen that appears, is as shown in FIG. 26 below.

FIG. 27 shows a page suitable for referring the previous recommendations select the Risk or Sub-Risk and then click Recommendations, which will display the screen shown in FIG. 28. If Assessment for a Company is to be made again, double-click on the Sub-Risk and the evaluation will be done again by overwriting the existing one.

It will thus be seen that the objects set forth above, among those made apparent from the preceding description, are efficiently attained and, since certain changes may be made in carrying out the above method and in the construction set forth without departing from the spirit and scope of the invention it is intended that all matter contained in the above description and as shown in the accompanying drawings shall be interpreted as illustrative and not in a limiting sense.

It is also to be understood that the following claims are intended to cover all of the risk categories and specific components of the invention herein described for any organization and all statements of the scope of the invention which, as a matter of language, might be said to fall therebetween.

What is claimed is:

1. In combination in a data processing system for assessing risk for financing a select technology enterprise, said system comprising:
a) a means for sorting in accessible memory a database on risk categories and characteristics of said risk categories relevant to financing said technology'
b) data processing means for evaluating a score of said individual risks describing the impact of risk on financing, said programming capable of computing a cumulative risk of current risk categories and further determining said impact of risk in relation to past performance; and
c) said data processing means further establishing an optimum financing risk based on current risk impact and past performance.

2. The system of claim 1, wherein the algorithmic system of evaluating risk includes evaluating risk categories comprising financing, personnel, tangible property, liability or technology type.

3. A computerized method of evaluating risk of financing in a technology enterprise, said method comprising identifying the risk categories relevant to said technology enterprise; quantifying the risk by determining a cumulative score for one or more risk categories; and taking corrective measures in a risk category which poses an impact on the financing.
